(19) United States
(12) Patent Application Publication
(10) Pub. No.: US 2005/0225964 A1
(43) Pub. Date: Oct. 13, 2005

(54) Safety flashlight for horses

(76) Inventor: Jacquelyn R. Simoni, Glen Ellyn, IL (US)

Correspondence Address: JENKENS & GILCHRIST, P.C., 225 WEST WASHINGTON, SUITE 2600, CHICAGO, IL, 60606, US

(21) Appl. No.: 11/101,892

(22) Filed: Apr. 8, 2005

Related U.S. Application Data
(60) Provisional application No. 60/561,176, filed on Apr. 8, 2004.

(51) Int. Cl. F21V 21/08

(52) U.S. Cl. 362/103

(57) ABSTRACT

A horse flashlight illuminates the area in front of a horse in dark conditions. The horse flashlight includes a housing containing at least one light source, a battery power supply for the light source, and a switch connected between the light source and the power supply for energizing and de-energizing the light source. An attachment device includes a band carrying the housing and adapted to surround the neck of the horse so that the housing is located in front of the chest of the horse. When energized, the light source has sufficient brightness to illuminate the area in front of the horse so that the horse owner can observe the illuminated area for control purposes.

### CROSS-REFERENCE TO RELATED APPLICATION

This invention claims the priority of U.S. Provisional Patent Application Ser. No. 60/561,176, filed Apr. 8, 2004, for “EQUESTRIAN LIGHT (NIGHT LIGHT FOR A HORSE)”.

### FIELD OF THE INVENTION

The present invention relates generally to a safety flashlight for horses and their owners and, more particularly, to a lightweight device that is attachable to mounting straps, and that contains at least one light emitting diode for the purpose of illuminating a region in front of the horse and making the horse visible.

### SUMMARY OF THE INVENTION

In accordance with the present invention, there is provided a horse flashlight illuminates the area in front of a horse in dark conditions, thereby eliminating the need for a horse owner to carry and direct a light source. The horse flashlight includes a housing containing at least one light source, a battery power supply for the light source, and a switch connected between the light source and the power supply for energizing and de-energizing the light source. An attachment device includes a band carrying the housing and adapted to surround the neck of the horse so that the housing is located in front of the chest of the horse. When energized, the light source has sufficient brightness to illuminate the area in front of the horse so that the horse owner can observe the illuminated area for control purposes.

The horse flashlight uses very bright LEDs (at least 5 mm with 10,000 med intensity) which provide sufficient illumination to serve as a flashlight replacement. The collar flashlight contains an on/off switch and a replaceable battery. The horse collar flashlight is attachable to an existing collar or attached to an elastic band so it can be easily put around the horse's head and taken off.

The flashlight is preferably carried on the horse's neck low enough so that the light shines out beneath its head, with two adjustable elastic bands. The horse light is preferably turned on and off remotely and also to switch from maximum brightness to energy-saving lower mode which illuminates only a portion of the lights. The remote should be able to turn on and off several horse lights at a time. For walking a horse along the road at night it would need a second red LED light if the horse is walking alone or a reflector if more than one horse is being ridden. The second light may clip to the back of the saddle or saddle blanket.

The light preferably has two sets of lights, one set shining straight ahead for distance illumination and one set to angle somewhat down to light up directly in front of the horse.

The lights are preferably protruding from the casing so the light is visible from the side. The outer lights should be angled out slightly. To prevent the lights from shining up into the horse's eyes, a rim may be positioned across the top of the LEDs. The light housing may be curved slightly so it fits around the horse's neck.

Horses need to be exercised on a regular basis. They also need to be cooled down after they are run before they are put back in their stalls. The invention is a very bright LED based light for a horse to provide sufficient illumination so that the horse can be walked at night. Additionally horses are often let out to pasture. A horse with a light on can be seen and located in a pasture at night. The light is preferably turned on and off remotely so that it is not necessary to walk out to the pasture to turn on the lights on each horse after it gets dark. If a horse is walked along the road at night a horse light and reflector can make it visible to cars and keep the horse and the rider safe at night. Nomally a very bright light is positioned to illuminate in the direction the horse is heading, and a red light or reflector is clipped to the back of the saddle or saddle blanket to make the horse visible from behind.

This invention is intended to provide sufficient illumination to allow a horse to be walked at night. It is not intended to allow a horse to be trotted, galloped or run at night.
1. A horse light makes the horse visible at night and therefore keeps him safe from cars and also more easily found in a pasture or if he runs off.
2. A horse light provides illumination so the rider can see where he's going at night. This extends the time a horse can be walked.

A remote control switch can be provided for on/off operation and also to switch between maximum illumination for riding and moderate illumination to see/locate the horse in pasture.

### BRIEF DESCRIPTION OF THE DRAWINGS

The invention may best be understood by reference to the following description taken in conjunction with the accompanying drawings, in which:

FIG. 1 is a front perspective view of a horse flashlight, according to one embodiment of the present invention,

FIG. 2 is a perspective view of the interior of the rear section of the horse flashlight of FIG. 1,

FIG. 3 is the same perspective view shown in FIG. 2 with the batteries removed,

FIG. 4 is a perspective view of one side of the circuit board contained in the front section of the horse flashlight of FIGS. 1-3,

FIG. 5 is a perspective view of the other side of the circuit board contained in the front section of the horse flashlight of FIGS. 1-3,

FIG. 6 is an electrical schematic of the electrical circuit contained in the horse flashlight of FIGS. 1-5, and

FIG. 7 is a diagrammatic front perspective of a horse flashlight with eight LEDs, according to another modified embodiment of the invention.

### DETAILED DESCRIPTION OF THE ILLUSTRATED EMBODIMENTS

Although the invention will be described next in connection with certain preferred embodiments, it will be understood that the invention is not limited to those particular embodiments. On the contrary, the description of the invention is intended to cover all alternatives, modifications, and equivalent arrangements as may be included within the spirit and scope of the invention as defined by the appended claims.

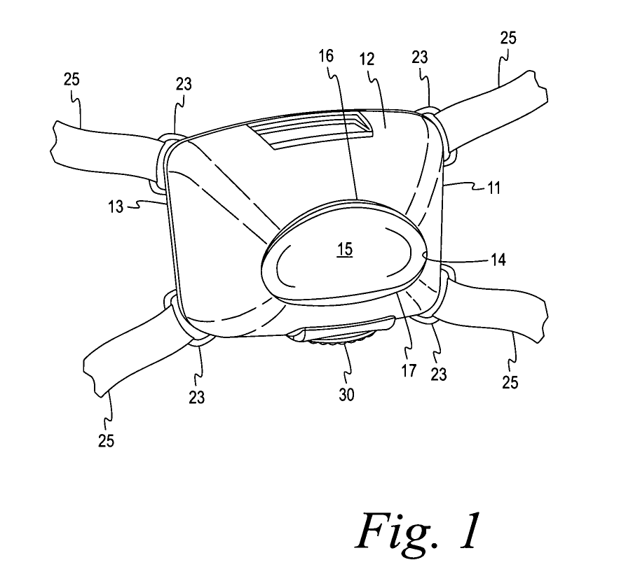

Turning now to the drawings, and referring initially to FIGS. 1-5, a horse flashlight 10, according to one embodiment of the present invention, includes a housing 11 made of molded plastic material and adapted to be attached to the neck of a horse (see FIG. 1). The housing includes a front section 12 and a rear section 13 which mate to form an internal cavity to contain the components described below. The front section 12 and the rear section 13 are molded, along their respective joining internal edges, to form a snap fitting of the kind well known in the state of the art. The front and rear sections 12 and 13 may thus be easily taken apart for access to the internal cavity. Alternatively, the two parts may be joined by an integral “living hinge” on one side and form an integral snap-type latch on the opposite side to hold the two sections 12 and 13 together.

The front housing section 12 forms a substantially oval aperture 14 for receiving a translucent or transparent lens 15 through which light from sources inside the housing can be transmitted forwardly from the housing. In the illustrative embodiment, the front housing section forms upper and lower rims 16 and 17 along the upper and lower edges of the aperture 14 to prevent light from being transmitted straight up or down from the aperture. The ends of the aperture, however, are unobstructed so that light can be transmitted laterally directly from the end edges of the aperture 14.

The corners of the housing form loops 23 for receiving and holding bands 25 adapted to fit around a horse's neck. The bands 25 may be made of an elastic material so that it can be used with horses of varying sizes.

An on/off switch 30 is located on the bottom of the front housing section 12. A pattern area 31 and a lip 32 are molded into the housing to provide finger and thumb surfaces that can be felt and gripped when opening the housing 11 to change batteries or to access the interior of the housing for other purposes such as to replace the light sources.

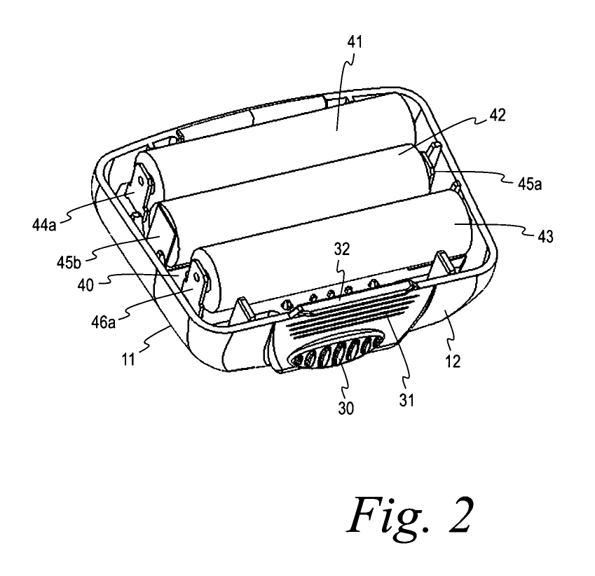

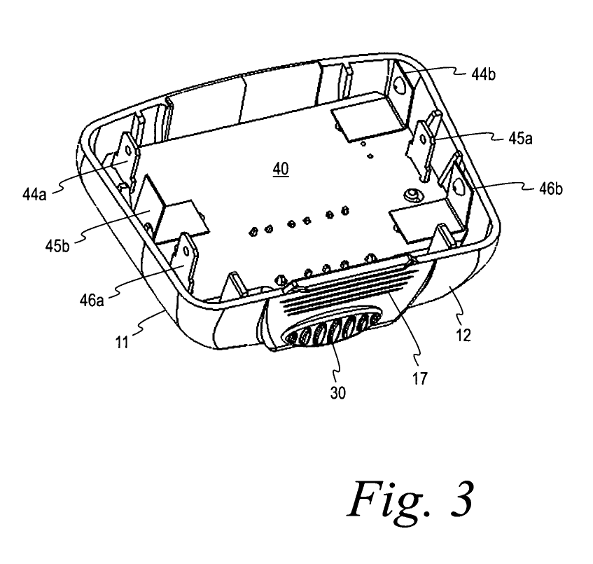

FIG. 2 shows the interior of the front housing section 12, which contains an internal circuit board 40. Three 1.5-volt alkaline batteries 41, 42 and 43 are mounted on the rear side of the circuit board 40, making contact with three pairs of conventional battery terminals 44a and 44b, 45a and 45b, and 46a and 46b attached to the circuit board 40. FIG. 3 is the same view as FIG. 2 with the batteries removed to more clearly show the battery terminals and their attachments to the circuit board 40.

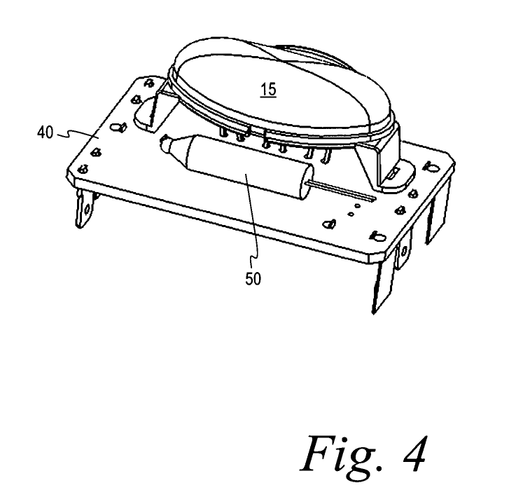

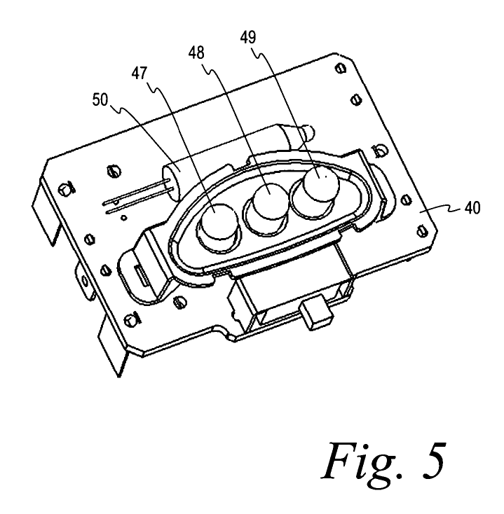

FIGS. 4 and 5 show the circuit board 40 without the housing. It can be seen that the lens 15 is mounted on the front side of the board 40, and three light emitting diodes (LEDs) 47, 48 and 49 are mounted on the board directly below the lens 15. The center LED 48 is positioned to emit a light beam directed straight forward, while the two side LEDs 47 and 49 are positioned to emit light beams directed slightly outwardly on opposite sides. The LEDs preferably emit white light with about 10,000 medium intensity. This combination of light beams is capable of illuminating an area extending as far as 200 feet in front of the horse, with a beam width that is at least 5 feet wide at a distance of about 10 feet in front of the horse. It will be understood that the LEDs may be varied in both number and size, but it is preferred that the source or sources be sufficient to illuminate an area extending at least 10 feet, most preferably at least 20 feet, in front of the horse.

An incandescent lamp 50 is also mounted on the front side of the board 40, for a purpose to be described below. Finally, the on/off switch 30 is also mounted on the front side of the board 40, adjacent the bottom edge of the board.

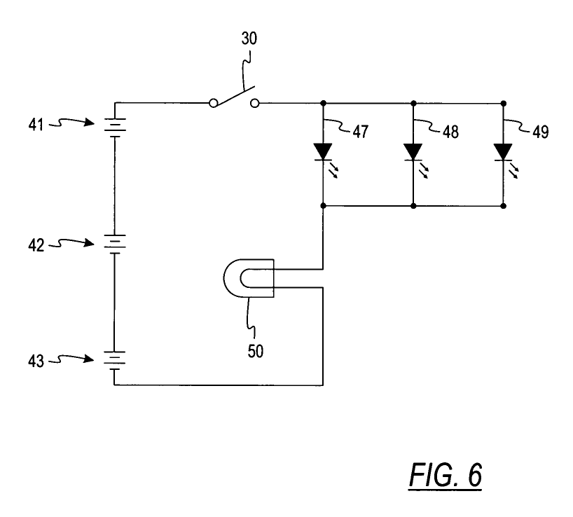

FIG. 6 is a schematic diagram of the electrical circuit provided the circuit board 40 to interconnect the various components mounted thereon. The three 1.5-volt alkaline batteries (AAA) 41-43 are electrically connected in series to provide 4.5 DC volts to the circuit through a sliding SPST on/off switch 30. The three white LEDS 47-49 are connected in parallel with each other and in series with the switch 30 so that all three LEDs are illuminated when the switch 30 is turned closed. The incandescent, tungsten-filament lamp 50, of the kind used for ornamental lighting, e.g., as in Christmas tree light string, is used as a constant current ballast resistor in the circuit. The current flowing through the tungsten filament of the lamp 50 varies with the available voltage from the batteries 41-43 due to the positive temperature coefficient of the filament, thereby providing a substantially constant amount of current to the LEDs 47-49. By using the incandescent lamp 50 as a variable resistor, the life of the batteries is extended and the intensity of the white LEDs 47-49 is more uniform over the life of the batteries 41-43.

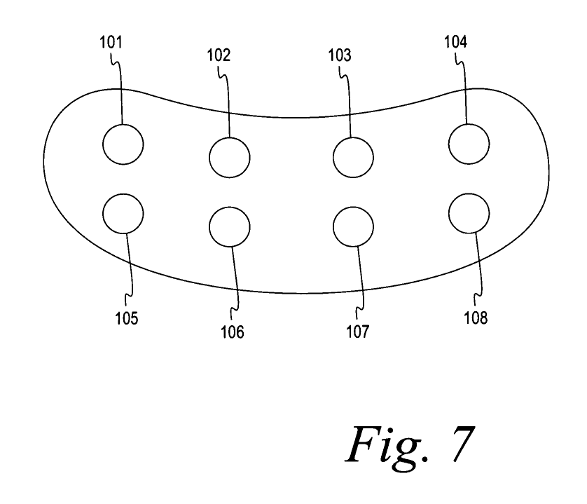

FIG. 7 illustrates a modified embodiment of the invention that utilizes eight LEDs 101-108. The center LEDs 102-107 illuminate the area directly ahead of the pet while the side LEDs illuminate areas to the side of the horse.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of illuminating the area in front of a horse in dark conditions, comprising:
attaching to the neck of the horse a housing containing at least one light source, a battery power supply for said light source, and a switch connected between said light source and said power supply for energizing and de-energizing said light source,
wherein said light source, when energized, is of sufficient brightness to illuminate the area in front of said horse so that the horse owner can observe the illuminated area for control purposes.

2. The method of claim 1 wherein said light source comprises at least one light emitting diode.

3. The method of claim 1 wherein said light source comprises multiple laterally spaced light emitting diodes

4. The method of claim 1 wherein said light source illuminates an area extending at least about 10 feet in front of the horse.

5. The method of claim 1 wherein said light source illuminates an area extending at least about 20 feet in front of the horse.

6. The method of claim 1 wherein said light source is a white light emitting diode.

7. The method of claim 1 wherein said light source emits a light beam that has a width of at least about 5 feet at a distance of about 10 feet in front of said horse.

8. A horse flashlight for illuminating the area in front of a horse in dark conditions, comprising:
a housing containing at least one light source, a battery power supply for said light source, and a switch connected between said light source and said power supply for energizing and de-energizing said light source, and
an attachment device including a band for carrying said housing and adapted to surround the neck of the horse so that said housing is located in front of the chest of the horse,
wherein said light source, when energized, is of sufficient brightness to illuminate the area in front of said horse so that said horse owner can observe the illuminated area for control purposes.
